(19) United States
(12) Patent Application Publication
(10) Pub. No.: US 2004/0205411 A1
(43) Pub. Date: Oct. 14, 2004

(54) Method of detecting malicious scripts using code insertion technique

(75) Inventors: Man-Pyo Hong, Seongnam-City (KR); Sung-Wook Lee, Suwon-City (KR); Si-Haeng Cho, Seoul (KR)

Correspondence Address: ROCCO S. BARRESE, ESQ., DILWORTH & BARRESE, LLP, 333 Earle Ovington Blvd., Uniondale, NY, 11553, US

(73) Assignee: Daewoo Educational Foundation

(21) Appl. No.: 10/735,985

(22) Filed: Dec. 15, 2003

(30) Foreign Application Priority Data
Mar. 14, 2003 (KR) 2003-16208

(51) Int. Cl. H02H 3/05

(52) U.S. Cl. 714/38

(57) ABSTRACT

The present invention relates to a method of detecting malicious scripts using a code insertion technique. The method of detecting malicious scripts according to the present invention comprises the step of checking values related to each sentence belonging to call sequences by using method call sequence detection based on rules including matching rules and relation rules, wherein the checking step comprises the steps of inserting a self-detection routine (malicious behavior detection routine) call sentence before and after a method call sentence of an original script, and detecting the malicious codes during execution of the script through a self-detection routine inserted into the original script. According to the present invention, since a detection routine is configured to operate during the execution of scripts, dynamically determined parameters and return values can be checked and thus detection accuracy can be improved. Further, since codes are inserted into only the scripts entering from the outside, unnecessary overhead is not generated. Furthermore, since the modified codes perform the self-detection even in systems in which additional anti-viruses are not installed, there is an advantage in that the propagation of malicious scripts can be suppressed.

### BACKGROUND OF THE INVENTION

1. Field of the Invention

The present invention relates to a method of detecting malicious scripts, and more particularly, to a technique capable of detecting malicious codes through continuous behavior monitoring by using a code insertion technique.

2. Description of the Related Art

Malicious codes are codes that have been created for the purpose of ah abnormal operation of a system or its harm behavior and computer viruses, worms, Trojan horses and the like are among them. Malicious scripts are referred to as malicious programs written in a script language. Most of the malicious scripts discovered up to now are written in Visual Basic Script, mIRC script and JavaScript, and some of them are written in PHP script, Corel Draw Script and the like.

A signature-based scanning method is widely used to detect these malicious scripts as well as binary malicious codes. However, since this method can detect only malicious codes from which signatures are extracted by a careful pre-analysis, the heuristic scanning, static analysis, behavior monitoring technique, etc. are mainly used to detect new unknown malicious scripts. For easy understanding of the present invention, a technique for detecting conventional unknown malicious scripts is discussed below.

First, the heuristic scanning corresponds to a method of organizing method calls or intrinsic function calls frequently used in malicious behavior into a database, scanning object scripts, and determining the object scripts as malicious scripts if dangerous calls occur over the predetermined number of times. Although this method exhibits relatively high speed and high detection rates, it has a severe disadvantage in that a false positive in which legitimate scripts are regarded as malicious codes is considerably high.

Second, to overcome such a disadvantage, the static analysis method has been proposed for accurately detecting malicious behavior by defining not the dangerous method calls but method sequences constructing the malicious behavior.

FIG. 1 shows an example of a Visual Basic Script code that performs self-replication via electronic mail for explaining the concept of the present invention. It can be confirmed from the figure that if a plurality of method calls is to establish any one malicious behavior, a special relationship should be necessarily maintained between their parameters and return values. For example, a “Copy” method in the fourth row copies a currently executing script into a file having a name of “LOVE-LETTER-FOR-YOU.TXT.VBS” and an “Attachments.Add” method in the seventh row attaches the copied file to a newly created mail object, so that the self-replication via mail can be accomplished. However, if a method of checking only the presence of the method calls is employed, a code containing any irrelevant method call for creating a script file “A” and then attaching a file “B” to the mail object may also be regarded as a malicious code. Thus, it results in a high false positive. This static analysis method has been attempted to check whether aforementioned file names and all relevant values such as “fso”, “c”, “out” and “male” as well as the presence of method calls match one another in order to overcome a high error rate produced from the other methods.

In practice, this malicious behavior cannot be defined by only a series of method sequences, but is composed of a combination of various methods or method sequences. In the static analysis technique, therefore, the malicious behavior has been modeled to be composed of a combination of unit behaviors each of which is composed of smaller unit behaviors or at least one method call, and each unit behavior and a method call sentence have been expressed as a single rule. For example, if a pattern of malicious behavior is defined considering only the methods shown in FIG. 1, it can be expressed as shown in FIG. 2. That is, FIG. 2 shows an example of a definition of self-replication behavior via a mail. As shown in FIG. 2, the rule is classified into a matching rule and a relation rule, which are identified by M and R, respectively, corresponding to first alphabets in rule names. A condition of the matching rule is satisfied if a sentence having the same pattern as that described in the right side of the FIG. 2 is present, while a condition of the relation rule is satisfied if a conditional expression in the right side of FIG. 2 is true.

Determination on the presence of malicious behavior through this static analysis has an advantage in that extremely low false positive can be guaranteed as compared to a simple detection technique in which only the frequency of occurrence of method calls usable for the malicious behavior is considered. However, there frequently occurs a case where it cannot be ultimately anticipated by only source code analysis before the execution of method calls what values do relevant parameters or return values have after the execution. Thus, there is a high possibility of false negative in which even actual malicious codes may not be detected. In other words, according to this technique, precise detection has been attempted through method call sequences of the malicious behavior. However, if even any one of values that can be determined only when the method call sequences are executed intervened in the sequences, it cannot be regarded as malicious behavior even though other conditions are satisfied. Thus, high false negative will be produced.

Third, the behavior monitoring technique corresponds to a technique for capturing and monitoring system calls necessary for the program execution and regarding a relevant program as a malicious code when a sequence of system calls that are determined to be malicious behavior appears. Since this technique performs the detection during the program execution, it has an advantage in that a precise execution path of the relevant code can be tracked and associated dynamic data can also be used. However, this technique has a disadvantage in that behavior monitors must be installed for all clients and overhead due to the monitoring for all programs under execution is large. More specifically, in electronic mail services where all data entering a specific domain pass through one server, the technique for coping with the virus can be classified into a server-side technique and a client-side technique according to a physical position of an anti-virus system. Since the server-side anti-viruses intercept malicious codes entering the specific domain at a gateway, the technique can be usefully employed in an electronic mail server and the like even in actual circumstances where it is hard to completely control all the clients. At this time, additional techniques for the detection of malicious codes on the server are not present, but it is common to use known techniques that are modified a little to be suitable to any operation on the server. However, the behavior monitoring technique that is performed on the basis of monitoring tools installed at each client cannot be employed in the server. Furthermore, even though the technique can be employed in virtual environments using the emulation, it still imposed a heavy burden on the server. Therefore, there is a problem in that it is difficult to use the behavior monitoring technique in reality.

Due to the problems in the conventional techniques as described above, current server-side anti-virus system loaded on the electronic mail server and the like operates on the basis of the signature-based scanning and takes a passive action of delaying the diffusion of new unknown malicious scripts by adding a filtering function or filename change function to the signature-based scanning.

### SUMMARY OF THE INVENTION

Accordingly, the present invention is conceived to solve the problems in the prior art. An object of the present invention is to provide a method of detecting malicious scripts using code insertion technique, in which relevant scripts can determine the presence of their own maliciousness without any external help upon the execution of the scripts, by inserting script codes capable of performing the self-detection into original script codes.

According to an aspect of the present invention for achieving the object, there is provided a method of detecting malicious scripts using code insertion technique, comprising the step of checking values related to each sentence belonging to call sequences by using method call sequence detection based on rules including matching rules and relation rules, wherein the checking step comprises the steps of inserting a self-detection routine (malicious behavior detection routine) call sentence before and after a method call sentence of an original script; and detecting the malicious codes during execution of the script through a self-detection routine inserted into the original script.

Preferably, the self-detection routine call sentence is composed of sentences for storing parameters and return values and calling a detection engine, said sentences being inserted before and after the method call sentence when the method call sentence matches with contents described in the matching rule, and the self-detection routine includes a rule-based detection engine for executing the relation rule related to a relevant matching rule when a method corresponding to the matching rule is called and detecting the presence of malicious behavior of the method call sequence, and methods for causing the parameters and return values of the method call sentence satisfying the matching rule to be stored into a buffer usable by the detection engine.

### BRIEF DESCRIPTION OF THE DRAWINGS

The above and other objects, features and advantages of the present invention will become apparent from the following detailed description of a preferred embodiment given in conjunction with the accompanying drawings, in which:

FIG. 1 shows an example of a Visual Basic Script code that performs self-replication via a mail:

FIG. 2 shows an example of a definition of self-replication behavior via a mail;

FIG. 3 is a diagram illustrating a concept of an application transformation system;

FIG. 4 is a diagram illustrating a concept of the present invention;

FIG. 5 is a flowchart illustrating a process of detecting malicious scripts according to the present invention;

FIG. 6 shows an example of rule description grammar according to the present invention;

FIG. 7 is a diagram illustrating a concept of a self-replication pattern extracted through an electronic mail from Visual Basic Script;

FIG. 8 shows an example of a relation rule definition for detecting the self-replication pattern through an electronic mail;

FIG. 9 shows an example of a method call code with a code insertion technique applied thereto; and

FIG. 10 shows an example of the generation of rule instances made through malicious behavior detection routine during the execution of scripts.

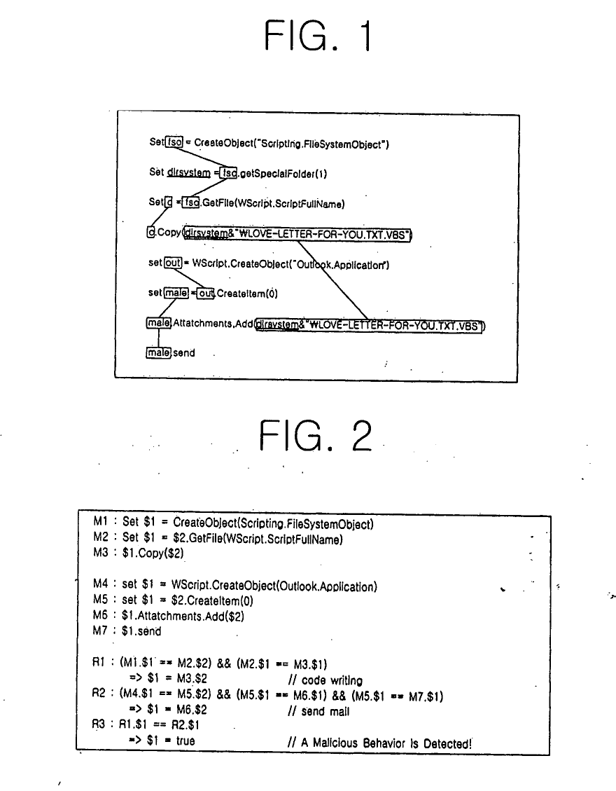

### DETAILED DESCRIPTION OF THE INVENTION

Hereinafter, the present invention will be described in detail with reference to the accompanying drawings.

An application transformation technique that is modified and employed to implement the present invention will be first explained. The application transformation technique suggested for code safety corresponds to a technique for converting a relevant code into a form on which a predefined policy can be enforced, when a code unreliable in its safety during the execution thereof is given. Therefore, when a transformed code is executed, an original operation is performed after it is checked whether system resources, which can be accessed by API calls whenever each API is called, are allowed.

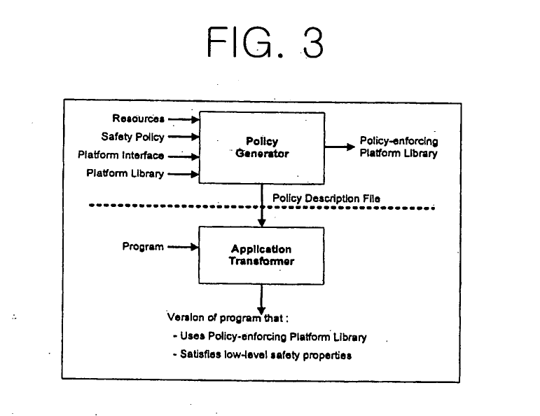

FIG. 3 is a diagram illustrating a concept of an application transformation system. Referring to this figure, an entire system is generally composed of a policy generator and an application transformer. The policy generator operates when the system is initially installed or security policy is changed. At this time, a safety policy including abstract descriptions on system resources and limitations on resource handling, and information on API libraries of a relevant platform and their resource use details are input in the policy generator. Therefore, when a platform library with codes necessary for policy enforcement inserted therein and a policy description file with an actual code correction guide described therein are generated, a preparatory work for the application transformation will be completed. If an object code is given, the application transformer replaces a specific API call of a relevant code with a call for a modified platform library with reference to the policy description file so that the predefined policy can be applied upon the execution of the object code. This application transformation technique can be usefully employed in access control enforcement for a mobile code having a similar form as a source program such as a source code or P-code. However, the technique cannot detect a pattern of malicious behavior, since it dose not consider a relation between respective function calls but determines only whether the execution of the specific API can be allowed.

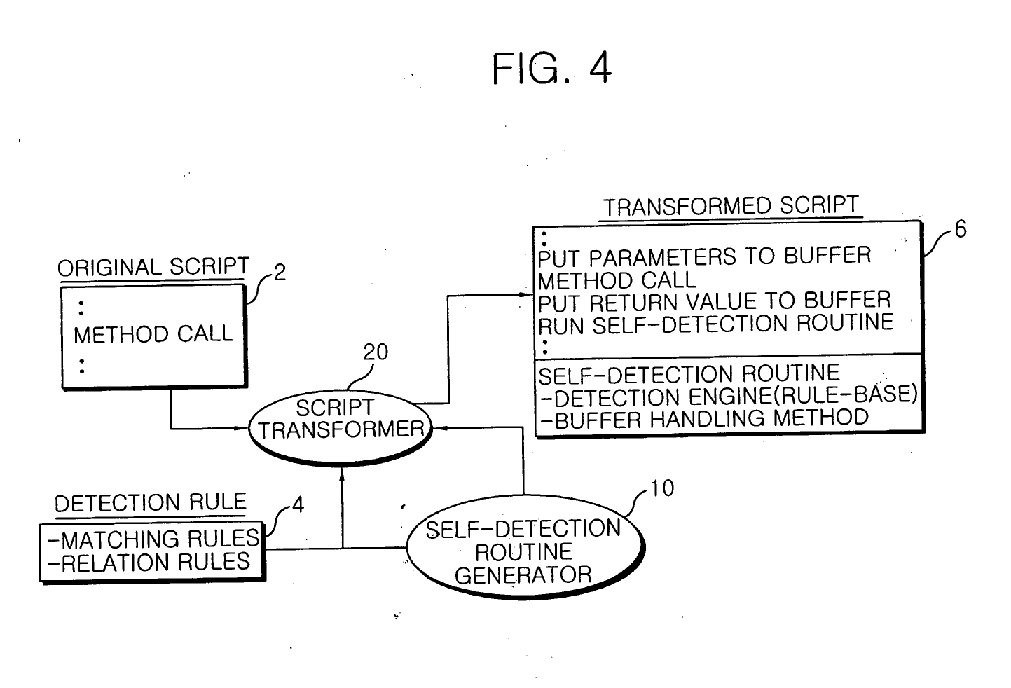

FIG. 4 is a diagram illustrating a concept of the present invention. In this figure, it is illustrated a technique for detecting malicious codes upon execution thereof by inserting a detection routine into a script source using the application transformation technique while employing a rule-based method call sequence detection method such as a static analysis technique. Referring to this figure, a self-detection routine generator 10 generates a self-detection routine (malicious behavior detection routine) capable of detecting malicious behavior based on detection rules 4 including matching rules and relation rules. A script transformer 20 transforms an original script 2 including method call sentences into a script 6 capable of continuously performing the self-detection during the execution through the method call sequence based on the detection rules 4 and the self-detection routine generated in the self-detection routine generator 10. That is, a script entering from the outside or suspected of its maliciousness is transformed so that it can be self-detected continuously at a predetermined time before the execution. At this time, the script transformer 20 does not modify a sentence itself described in the original script 2 but merely causes additional codes to be inserted into the script.

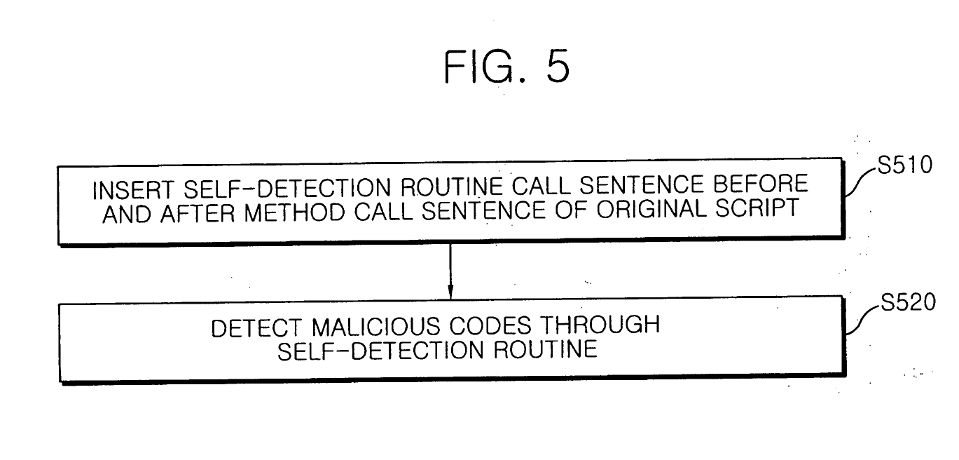

Now referring to FIG. 5, a process of detecting malicious scripts by employing the method call sequence detection method based on rules including the matching and relation rules, as illustrated in FIG. 4, and by checking the values related to each sentence belonging to the call sequences. First, a self-detection routine call sentence is inserted before and after a method call sentence of the original script (S5 10). Therefore, when the original script is executed, the malicious codes can be detected through a self-detection routine inserted into the original script (S520). Next, codes to be inserted into a script will be discussed. A first kind of the codes corresponds to sentences that take parameters and return values and call the self-detection routine, and the sentences are inserted before and after the method call sentence of the original script 2. That is, the sentences are described as “put parameter to buffer”, “put return value to buffer”, and “run Self-Detection Routine” in the transformed scripts 6 of FIG. 4, and actually have the same structure as shown in FIG. 9. These sentences are not inserted into all the method call sentences, and they are inserted only before and after the method call sentences exhibiting a pattern corresponding to that described in the matching rule. At this time, the script transformer 20 takes necessary values through proper analysis of the matching rule and inserts codes for calling the self-detection routine. This is because the number of parameters to be taken varies according to the methods and the method calls with no return value are also present.

A second kind of the codes is the self-detection routine. This routine is independent of contents of a script and varies only according to rules that define malicious behavior. In other words, since this routine is not modified so long as the definition of malicious behavior is not modified, it can be generated in advance by the self-detection routine generator 10 and is configured to comprise a rule-based detection engine and buffer handling methods. Since the detection engine is performed only when the methods corresponding to the matching rule are called, it functions to execute all the relation rules related to a relevant matching rule and check whether method call sequences up to now establish the malicious behavior. The buffer handling methods correspond to methods for causing the parameters and return values of the method call sentences satisfying the matching rule to be stored into a buffer usable by the detection engine.

This detection technique is not limited to a specific script language but can allow the same algorithm to be applied to a plurality of script languages by differently defining only a set of rules being currently used. Particularly, in Microsoft Windows, a plurality of languages such as Visual Basic Script and JavaScript are executed through the same windows scripting host and utilize the same run-time object and environment. Therefore, the sets of rules for use in different languages can be defined by changing only the matching rules according to each script grammar.

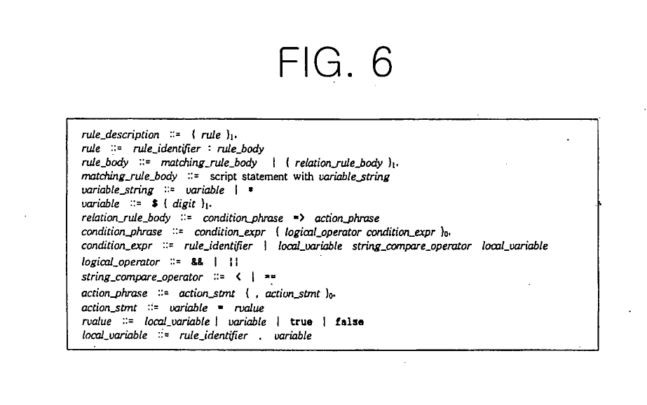

Now, for easy understanding of the present invention, points of view to be considered for implementing the aforementioned code insertion technique and the implementation thereof will be explained. First, it is preferred that rules for use in the definition of malicious behavior are changed into rules that is similar to but more simple and consistent than that of the conventional code static analysis techniques. FIG. 6 shows an example of rule description grammar according to the present invention. Referring to FIG. 6, one rule description file is composed of a plurality of rule definitions, and each rule is composed of a rule ID (rule_identifier) and a rule body (rule_body). A format of the rule body depends on the matching and relation rules. The matching rule takes the format of a general script sentence and further includes a rule variable (variable_string). In addition, the relation rule is composed of a condition phrase (condition_phrase) and action phrase (action_phrase) and executes the content in the action phrase when the conditions of the condition phrase are satisfied. The condition phrase is composed of one or more condition expressions, each of which is described to check whether a specific rule has been already satisfied specific variable values of two rules are equal to each other, or one of the specific variable values is included in the other value.

By the way, the conventional rule techniques was complicated primarily because they do not support logical operators such as AND and OR. That is, assuming that each of A, B and C is a single condition expression (condition_expr), a condition “(A AND B) OR C” should be described as follows:

```
R1: cond A
R2: precond A
    cond B
    action $global = true
R3: cond C
    action $global = true
```

That is, the condition must be described in such a manner that a condition connected by AND is separated into a plurality of rules each of which is described in a pre-satisfied condition phrase (pre-condition phrase) and a portion processed by OR is described to change a global variable initialized as “false” to “true” when each condition expression is satisfied. Since it makes the rule techniques and subsequent decryption difficult, it should be modify so that a rule technique can be simple and coincident with logic of malicious behavior as a whole by allowing the logical operators to be directly used in the condition expression instead of using the global variable.

In the meantime, actual rule definition can be obtained through empirical analysis of conventional malicious codes. As it has been theoretically proved, there is no set of heuristic rules capable of accurately detecting all possible malicious behaviors and the set of rules should be continuously updated whenever new malicious codes or behavior patterns appear. Noting that the malicious codes can be clearly differentiated from legitimate programs according to whether they can perform the self-replication, the self-replication behavior patterns of the malicious scripts known up to now can be summarized as listed in Table 1.

TABLE 1

| Classification | Contents |
|---|---|
| Self-replication in local system | Make a malicious script's own replica in an object system. |
| | Speaking strictly, the self-replication can be classified into |
| | a case where non-existing new replicas are created and a |
| | case where contents of a script file existing in the object |
| | system are replaced with malicious script's own contents |
| Self-replication via electronic mail | Send an electronic mail with a malicious script attached |
| | thereto to an account listed in an address list |
| Self-replication via IRC | Modify an initialized script of an IRC client such as mIRC |
| | and allow a malicious script itself to be sent when chatting |
| | partner is connected |
| Self-replication via share folders | Search network share folders and copy a malicious script |

Since each malicious behavior listed in Table 1 is defined as one or more unit behaviors or method call patterns and each unit behavior is again defined as one or more sub-unit behavior or method call sub-pattern, a specific malicious behavior can be expressed in the form of a tree where one rule is represented as one node. Therefore, completed rules can be obtained by analyzing a plurality of known malicious scripts, arranging code patterns for performing the self-replication in the form of a tree, and then describing the code patterns in a defined grammar.

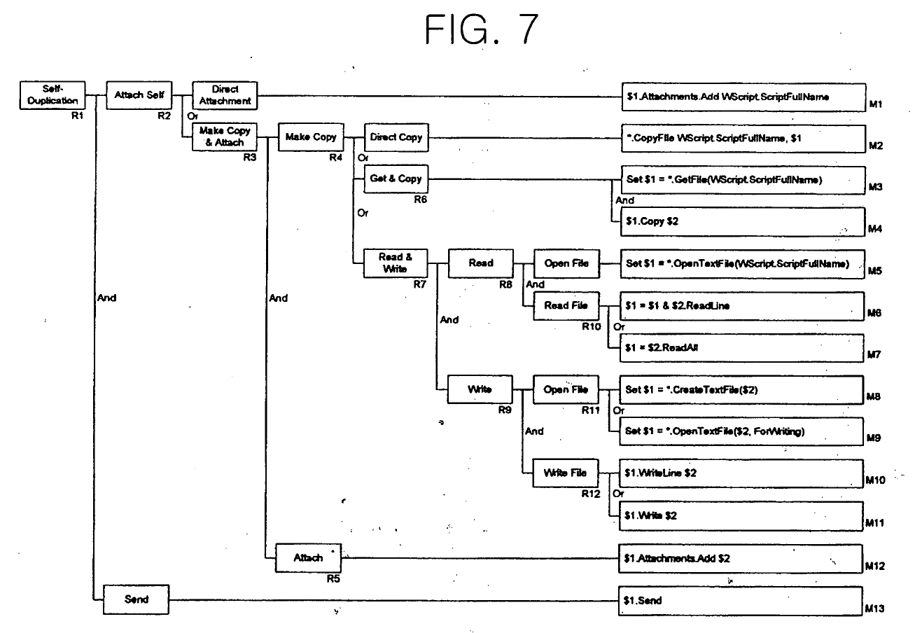

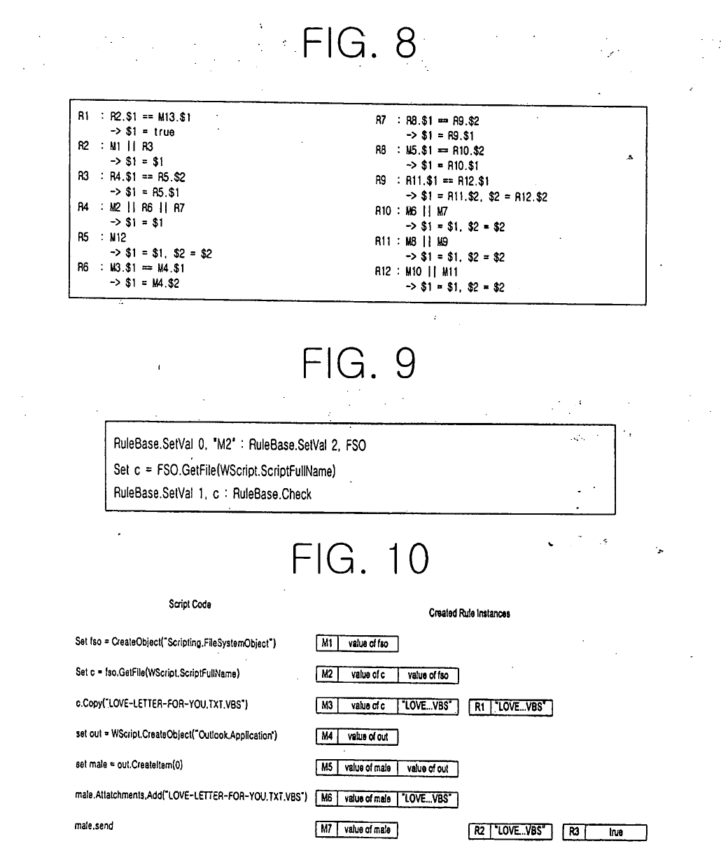

For example, a tree structure shown in FIG. 7 can be obtained by extracting a variety of self-replication patterns using an electronic mail from known Visual Basic malicious scripts and arranging the extracted patterns into a single tree. Since terminal nodes in the tree structure shown in FIG. 7 can be used as the matching rules without any modification, relation rules shown in FIG. 8 can be obtained by expressing the tree structure according to the defined grammar in consideration of the meanings of intermediate nodes.

Symbol “*” used in the matching rules of the rule descriptions shown in FIG. 7 mean wildcards that can match with any kinds of tokens. In addition, the relation rules for checking only the presence of rules in the condition phrases operate by recognizing the right side of the action phrase as rule variables of rules satisfying the conditions even though additional rule IDs are not described in the right side of the action phrase. For example, in the case of R4, the action phrase is interpreted as “$1=M2.$1” if the condition expression is satisfied because a rule of M2 is satisfied, and the action phrase is interpreted as “$1=R6.$1” if the condition expression is satisfied because a rule of R6 is satisfied. Therefore, the rule descriptions can be simplified.

According to these rule descriptions, behavior patterns written in not only the Visual Basic Script but also other script languages can be detected in the same way. Actually, if only a first token “Set” of R3, R5, R8 and R9 in the matching rules shown in FIG. 7 is removed, the self-replication behavior via a mail can be detected in the JavaScript environment. Contrary to the Visual Basic Script in which a sentence “Set” should be necessarily used for the assignment of objects, the JavaScript can perform this object assignment in the form of a general assignment statement. Thus, the same detection operation can be performed without any modifications of the relation rules, if a difference in the above grammar is merely considered.

Now, a process of inserting script codes will be described in detail. If an object script is given, codes for causing parameters and return values to be stored in the buffer and calling functions for inspecting malicious behavior should be inserted into the object script before and after calling the methods belonging to method sequences constituting malicious behavior. This process is accomplished by the script transformer. Method call codes after the code insertion are modified as shown in FIG. 9. “FSO.GetFILE” in the second row of FIG. 9 is a method to be checked, and first and third rows are codes that are inserted to check the operation of this method. A “RuleBase” object is an object for providing rule definitions and relevant malicious behavior detection routines, and it is implemented in such a manner that this object is appended to an end of modified codes after the code insertion has been made. The code of this object is generated by the self-detection routine generator, which will be described in detail later.

Only methods “SetVal” and “Check” shown in FIG. 9 are used to check the method calls. The method “SetVal” assigns a set value to a given location of a buffer arranged in an array, and the method “Check” functions as a detection engine for perform a check according to rules with reference to contents of the buffer. At this time, since the buffer is arranged in an array to store a plurality of values therein, all the parameters and return values of the matching rule as well as a name of a relevant matching rule are stored in a single array. According to many script languages such as Visual Basic Script or JavaScript, the same operation can be performed by only an array without use of an additional separate structure since any types in general programming languages can be put into a single variable without any limitation. The meanings of data stored in respective locations of the array of the buffer are defined as Table 2 below.

TABLE 2

| Location of array | Meaning | Remark |
|---|---|---|
| 0 | Name of coincident matching rule | Character string |
| 1 | Return value | Not name but |
| | | values during |
| | | execution are |
| | | stored |
| 2 | Object for providing called | |
| | methods | |
| Over 3 | Parameters | |

The operation of the script transformer is summarized as follows. First, the matching rules are loaded from the rule description file. Second, sentences for initializing the malicious behavior detection routines are output (RuleBase object initialization method call). Third, the following operation is performed for all the sentences in a given script. That is, if one read sentence is coincident with the matching rules, the parameters and return values are stored before and after the read sentence and the read sentence is then output together with a self-detection routine call sentence. However, if the read sentence is not coincident with the matching rules, it is output as it is. Fourth, a malicious behavior detection routine code (RuleBase class code) obtained from the self-detection routine generator is added to each read sentence.

Next, a process of adding the malicious behavior detection routine will be described in detail. Malicious behavior detection related routines for inserting method call information into a buffer and performing the malicious behavior detection can be combined into one class, i.e. the aforementioned RuleBase class. Public methods provided by this class are listed in Table 3 below.

TABLE 3

| Method | Content |
|---|---|
| Init | Class initialization |
| SetVal(pos, value) | Assign a value of ‘value’ to pos-th of buffer. |
| Check | Check the presence or absence of malicious |
| | behavior |

When the code insertion is performed, values required for the check are stored in the buffer using the “SetVal” method and a code for calling the “Check” method is inserted before and after the method call sentence of the format described in the matching rules. Actually, the “Check” method finds which matching rule called the “Check” method itself with reference to only contents of the buffer and functions only as an entry point (or gateway) for calling the method in which the relevant matching rule has been implemented. In other word, each rule is represented as one private method belonging to a malicious behavior detection class and the self-detection routine generator automatically generates each method with reference to the rule definitions.

At this time, the contents of the method in which each rule has been implemented are different in case of the matching and relation rules. Since the matching rule is performed only when a relevant sentence is matched with a given format, one rule instance is generated to record that the matching for a relevant rule occurs unconditionally, and higher-level rules are then checked. The rule instance corresponds to a data structure including information on the relevant rule and is generated when a given condition is satisfied. Since the information stored in the matching rule instances includes the values of matching rule variables such as $1 and $2, the instances can be generated by merely assigning the values stored in the buffer to proper locations of the generated instances.

The operation of the relation rule is basically the same as that of the matching rule, except that the relation rule always first checks condition expressions, and generates instances of a relevant rule and then checks higher-level rules only when the condition expressions are satisfied. Here, the satisfaction of the condition expressions means that there exist rule instances satisfying a relevant condition expression. In addition, the higher-level rules are referred to as rules with a relevant rule included in their own condition expressions and correspond to rules located at parent nodes of the relevant rule when the rules are represented in the form of a tree structure shown in FIG. 7. Thus, the higher-level rules can be determined prior to the execution through analysis of the rule definitions.

The operation of the self-detection routine generator is summarized as follows. First, the matching and relation rules are loaded. Second, the loaded rules are analyzed and the higher-level rules of each of the loaded rules are then recorded. That is, one rule Rc is selected for all relation rules, a set S of rules appearing in a condition expression of the selected rule is obtained, and a rule Rc is then recorded as a higher-level rule for all rules belonging to the set S. Third, corresponding methods are generated for all the matching rules. At this time, the contents of the methods are as follows. That is, new rule instances are generated with reference to the contents of the buffer and a method corresponding to the higher-level rule is called. Fourth, corresponding methods are generated for all the relation rules. At this time, the contents of the methods are as follows. That is, a rule body portion is parsed and transformed in accordance with a script grammar, and a method corresponding to a higher-level rule is called.

FIG. 10 shows an example of the generation of rule instances made through malicious behavior detection routine during the execution of scripts. Referring to this figure, the rule instances in the right side of the figure are generated whenever each row of the script in the left side is executed. Fields appended after names of respective rule instances mean values of rule variables described as $1 and $2 in the relevant rule definition.

According to a method of detecting malicious scripts using a code insertion technique as described above, since a detection routine is configured to operate during the execution of scripts. dynamically determined parameters and return values can be checked, and thus, detection accuracy can be improved. Further, since codes are inserted into only the scripts entering from the outside, unnecessary overhead is not generated. Furthermore, since the modified codes perform the self-detection even in systems in which additional anti-viruses are not installed, there is an advantage in that the propagation of malicious scripts can be suppressed. Moreover, since a set of rules used can be set in a various manner without any limitation to a specific script language, the detection method can be applied to a plurality of script languages without any limitation.

Although the present invention has been described in detail in connection with the preferred embodiment of the present invention, it will be apparent to those skilled in the art that various changes and modifications can be made thereto without departing from the spirit and scope of the invention. Thus, simple modifications to the embodiment of the present invention fall within the scope of the present invention.

What is claimed is:

1. A method of detecting malicious scripts using code insertion technique, comprising the step of:
checking values related to each sentence belonging to call sequences by using method call sequence detection based on rules including matching rules and relation rules,
wherein the checking step comprises the steps of:
inserting a self-detection routine (malicious behavior detection routine) call sentence before and after a method call sentence of an original script; and
detecting the malicious codes during execution of the script through a self-detection routine inserted into the original script.

2. The method according to claim 1, wherein the self-detection routine call sentence is composed of sentences for storing parameters and return values and calling a detection engine, said sentences being inserted before and after the method call sentence when the method call sentence matches with contents described in the matching rule, and wherein the self-detection routine includes a rule-based detection engine for executing the relation rule related to a relevant matching rule when a method corresponding to the matching rule is called and detecting the presence of malicious behavior of the method call sequence, and methods for causing the parameters and return values of the method call sentence satisfying the matching rule to be stored into a buffer usable by the detection engine.
